(19) United States
(12) Patent Application Publication
(10) Pub. No.: US 2015/0106849 A1
(43) Pub. Date: Apr. 16, 2015

(54) System and Method for Automatic Video Program Channel Generation

(71) Applicant: Yang Pan, Singapore (SG)

(72) Inventor: Yang Pan, Singapore (SG)

(21) Appl. No.: 14/052,742

(22) Filed: Oct. 13, 2013

(51) Int. Cl. H04N 21/262; H04N 21/643; H04N 21/4143; H04N 21/414; H04N 21/81; H04N 21/482; H04N 21/258

(52) U.S. Cl. CPC H04N 21/26291; H04N 21/482; H04N 21/64322; H04N 21/25891; H04N 21/41407; H04N 21/812; H04N 21/4143
USPC 725/42; 725/46

(57) ABSTRACT

System and method for delivering video programs from a cloud to an electronic terminal is disclosed. Channels may be generated based upon personal data of a user. Channels may also be generated by the user's inputs through a user input device of the terminal. The user may select to access video programs in the cloud either through generated channels or through a search engine. Advertising messages can also be delivered based upon disclosed system.

### CROSS-REFERENCE TO RELATED APPLICATIONS

Not applicable.

### BACKGROUND

1. Field of Invention

This invention relates generally to video program delivery. More specifically, the invention relates to system and method for delivering video programs from the Internet to electronic terminals.

2. Background-Description of Prior Art

Personal mobile devices have gained significant popularity in recent years. Users are using the mobile device such as, for example, iPhone, iPod and iPad from Apple Inc, Cupertino, Calif., to enjoy media assets and to access the Internet services. Methods for delivering video programs to users by employing personal mobile devices have been developed based on a search engine.

Because of significantly larger display size and comfortable environment in a living room, many of video programs have still been delivered to users through a television (TV) system. Video programs from satellite TV operators or from cable TV operators are broadcasted through channels based on predetermined schedules.

Some users may prefer to use the search engine to access video programs from the Internet. Some other users may prefer to use channels to access video programs even if the programs are located in the Internet. With increased amount of video contents delivered through the Internet, it is desirable to have system and method for delivering video programs through both search engine and predetermined channels. Users can, therefore, select preferred methods based on personal preferences.

### SUMMARY OF THE INVENTION

It is an object of the present invention providing a system and method for automatic channel generation based on personal data of a user. Therefore, video programs in a cloud or in the Internet can be accessed through channel selection using an electronic terminal.

It is another object of the present invention providing a system and method for automatic channel generation based additionally on the user's inputs through the electronic terminal.

It is yet another object of the present invention providing a user interface for accessing user specific channels through anyone of a plurality of electronic terminals.

It is still another object of the present invention providing a method of delivering advertising messages based upon disclosed system and method.

In one embodiment, an exemplary system comprises an electronic terminal connected to the Internet (cloud). User specific channels can be determined by a channel generation engine based on personal data of the user. In one implementation, the personal data is stored in the Internet. In another implementation, the personal data is stored in the electronic terminal. The user specific channels may be modified by the user.

In another aspect, the user specific channels include user defined channels. The user defined channels may be generated by channel generation engine based on the user's inputs through a user input device of the electronic terminal.

A user interface renders user specific channels on a display of the electronic terminals. Displayed channels may further include generic channels from the Internet. The user interface may include user selectable icons including a channel selector and a search engine at a first hierarchical level of the user interface.

In another embodiment, the user interface including user specific channels are stored in the Internet. The user specific channels can be rendered to anyone of a plurality electronic terminals including but not limited to smart phones, smart watch, tablet computers, laptop computers, game console and televisions.

In another aspect, advertising messages can be delivered through the system. In response to selecting of a channel by the user, a program list is displayed on the display of the electronic terminal. The program list includes at least a past program, a current program and a scheduled future program. The past and future program may be viewed with advertising messages. The current program may be viewed without advertising messages.

### BRIEF DESCRIPTION OF THE DRAWINGS

For a more complete understanding of the present invention and its various embodiments, and the advantages thereof, reference is now made to the following description taken in conjunction with the accompanying drawings, in which:

FIG. 1A is a schematic diagram of an exemplary video delivery system for delivering video programs from the cloud to an electronic terminal in accordance with a first embodiment;

FIG. 1B is a schematic diagram of an exemplary video delivery system for delivering video programs from the cloud to an electronic terminal in accordance with a second embodiment;

FIG. 1C is a schematic diagram of an exemplary video delivery system for delivering video programs from the cloud to an electronic terminal in accordance with a third embodiment;

FIG. 2A is a schematic diagram illustrating user specific channels are displayed on a display of an electronic terminal;

FIG. 2B is a schematic diagram illustrating cloud generic channels are displayed on a display of an electronic terminal;

FIG. 3 is a schematic diagram illustrating user specific channels and cloud generic channels are displayed on a display of an electronic terminal;

FIG. 4 is a schematic diagram illustrating an exemplary user interface at its first hierarchical level;

FIG. 5 is a flowchart illustrating exemplarily operation of generating cloud defined channels;

FIG. 6 is a flowchart illustrating exemplarily operation of generating user defined channels;

FIG. 7 is a flowchart illustrating exemplarily operation of modifying cloud defined channels by a user of the electronic terminal;

FIG. 8 is a flowchart illustrating that a video program is delivered from the cloud to the electronic terminal based on the system;

FIG. 9 is a schematic diagram illustrating an exemplary program list including past programs, current programs and scheduled programs;

FIG. 10 is a flowchart illustrating exemplarily that advertising messages are delivered based upon the system.

### DETAILED DESCRIPTION

One or more specific embodiments of the present invention will be described below. These described embodiments are only exemplary of the present invention. Additionally, in an effort to provide a concise description of these exemplary embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business related constraints, which may vary from one implementation to another. Moreover, it should be appreciated that such a development effort might be complex and time consuming, but would nevertheless be a routine undertaking of design, fabrication, and manufacture for those of ordinary skill having the benefits of this disclosure.

“Cloud” and “the Internet” will be used without a difference in the present disclosure. “Advertising messages” used in the present disclosure include but are not limited to video programs, audio messages, texts, images, photographs and websites.

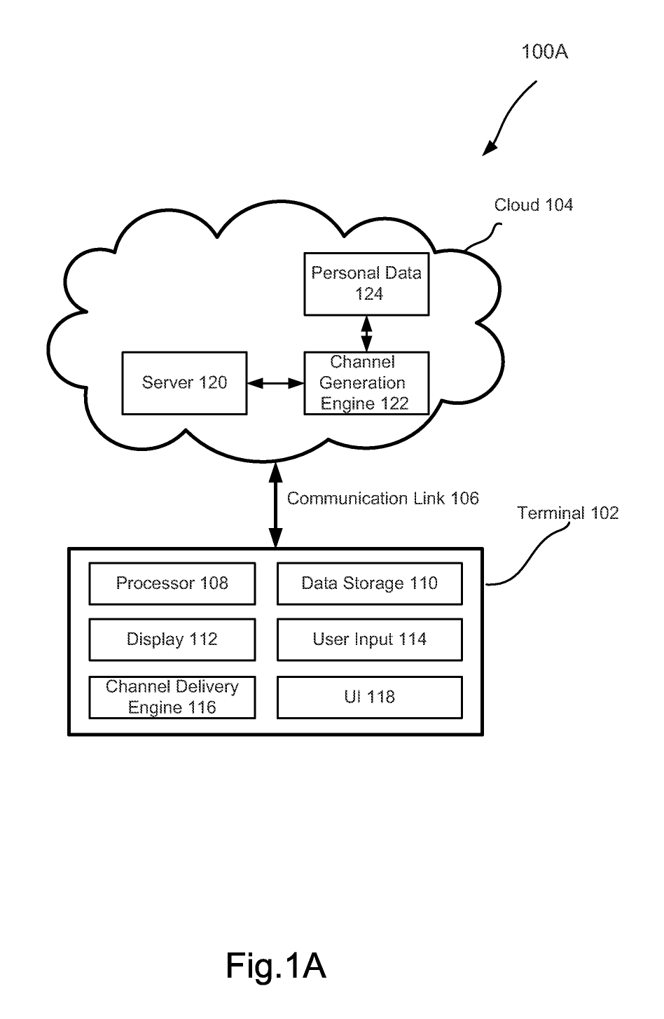

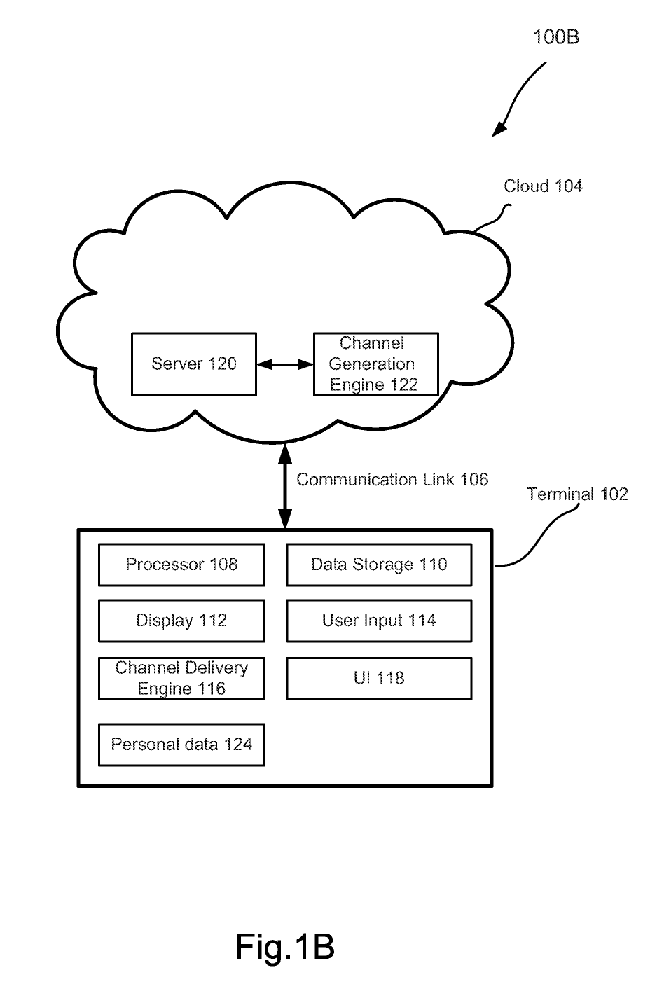

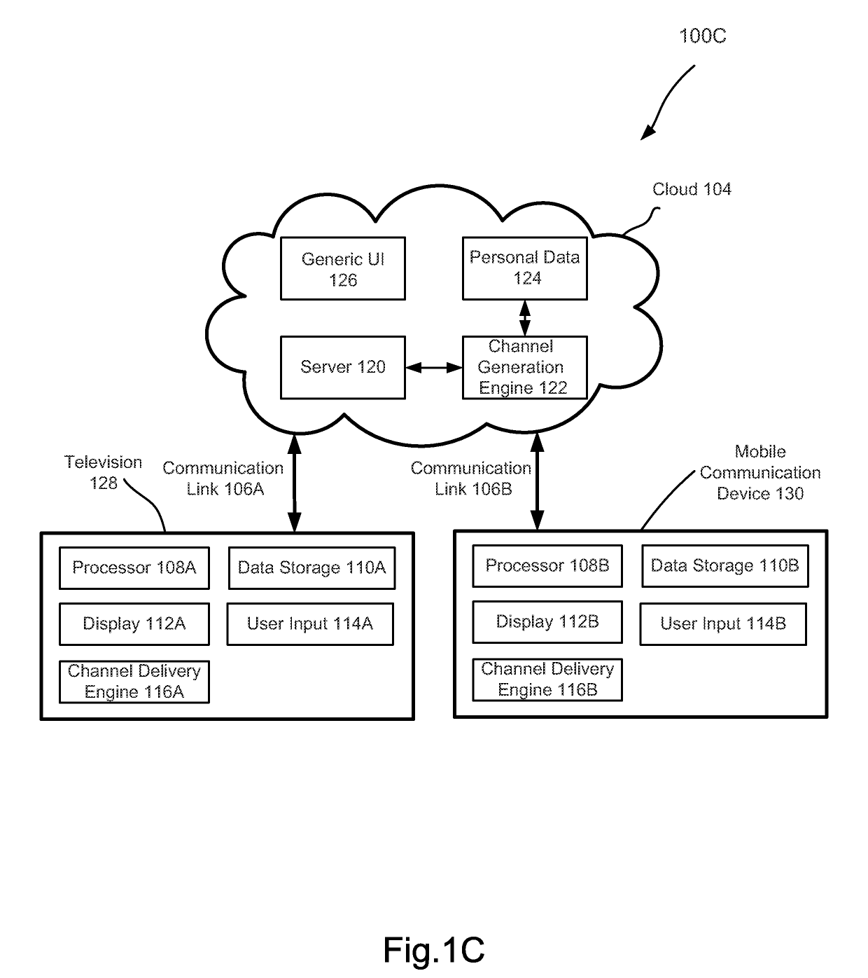

FIG. 1A is a schematic diagram illustrating an exemplary video delivery system 100A in accordance with the first embodiment. System 100A includes electronic terminal 102 that is connected to cloud 104 through communication link 106. Terminal 102 includes but is not limited to a television, a smart phone, a smart watch, a tablet computer, a laptop computer, a game console and a portable media player. Communication link 106 may be a wired broadband connection or a wireless broadband connection. Terminal 102 includes a processor 108 pertaining to controlling operation of the electronic terminal. Terminal 102 further includes data storage 110. Personal media files including video programs may be stored in data storage 110. Terminal 102 further includes a display 112 and a user input device 114. UI 118 is pertaining to displaying a hierarchical user interface in display 112 for guiding the user to select a video program.

System 100A includes channel generation engine 122 operated by server or virtual server 120 in cloud 104. In an exemplary case, channel generation engine 122 is a piece of software executable by server 120. Channel generation engine 122 creates cloud defined channels based upon the user's personal data 124. According to the first embodiment, personal data 124 is stored in cloud 104. Metadata of video programs viewed by the user may be recorded and be categorized in personal data 124. Metadata includes titles of the video programs. Demographical information about the user may also be included. Demographical information includes but is not limited to sex, age, education and residential locations of the user.

Cloud defined channels may include specialized channels such as, for example, a channel dedicated for sports or a channel dedicated for music. Cloud defined channels may also include generic channels with mixed video categories.

A cloud defined channel includes a list of video programs. Some of the video programs have been stored in cloud 104 at the moment the list of programs is created. Some of the video program such as, for example, real time news may not have been created at the moment the listed is created. Similar to a conventional TV program, the real time news is rendered according to the schedule when the channel is selected by the user.

The cloud defined channels are transmitted to terminal 102 through communication link 106 Channel delivery engine 116 is operated by processor 108 to display cloud defined channels through UI 118. Channel delivery engine 116 is a piece of software executable by processor 108.

In another aspect, channels can be defined by the user. User inputs are received by processor 108 through user input device 114. Received user inputs are transmitted to channel generation engine 122 through communication link 106. User defined channels are generated and are transmitted to terminal 102 through communication link 106.

Cloud defined channels and user defined channels are classified as user specific channels. Cloud 104 may also include cloud generic channels that are broadcasted to many users. The user may select a group of could generic channels that are interested to him or her.

In response to a channel selected by the user through UI 118, metadata of selected channel is transmitted to server 120. The video program is retrieved by server 120 and is delivered to terminal 102 accordingly.

The program list may include past programs, a current program and scheduled future programs. The past programs may be stored in cloud 104. The user can select the past program for viewing through UI 118. Some of scheduled future programs that have been stored in cloud 104 can also be selected and be viewed.

FIG. 1B is a schematic diagram of an exemplary video delivery system 100B in accordance with a second embodiment. In system 100B, personal data 124 is stored in electronic terminal 102. Channel generation engine 122 receives personal data from terminal 102 through communication link 106 and determines cloud defined channels based upon received personal data.

FIG. 1C is a schematic diagram of an exemplary video delivery system 100C in accordance with a third embodiment. A plurality of electronic terminals can be connected to cloud 104. The electronic terminals include but are not limited to television 128 and mobile communication device 130. Television 128 and mobile communication device 130 are connected to cloud 104 through communication links 106A and 106B. 106A and 106B may be the same type of broadband communication links. 106A and 106B may be different type of communication links. User specific channels can be delivered to television 128 and mobile communication device 130 through generic UI 126 in cloud 104. In one implementation, generic UI 126 is a web type of user interface. A list of user specific channels can be rendered to the user through either television 128 or mobile communication device 130 when the user clicks a link or actuates an icon for an application (APP) to access the website. In response to user selection of one of displayed channels, a list of programs is displayed. The user can either view a program being broadcasted or select a past or scheduled future program for viewing.

The user can use anyone of the plurality of electronic terminals to define the user defined channels.

The user can use anyone of the plurality of electronic terminals to select generic cloud channels.

Mobile communication device 130 includes but is not limited to a smart phone, a smart watch, a tablet computer, a laptop computer, a portable game console and a portable media player. System 100C can include more than one type of mobile communication devices.

A television will be used exemplarily to illustrate the present inventive concept through the remaining part of the present disclosure. The inventive concept can be readily extended to any other electronic terminals include but are not limited to a smart phone, a smart watch, a tablet computer, a laptop computer, a desktop computer, a game console and a portable media player. All such variations fall into scope of the present inventive concept.

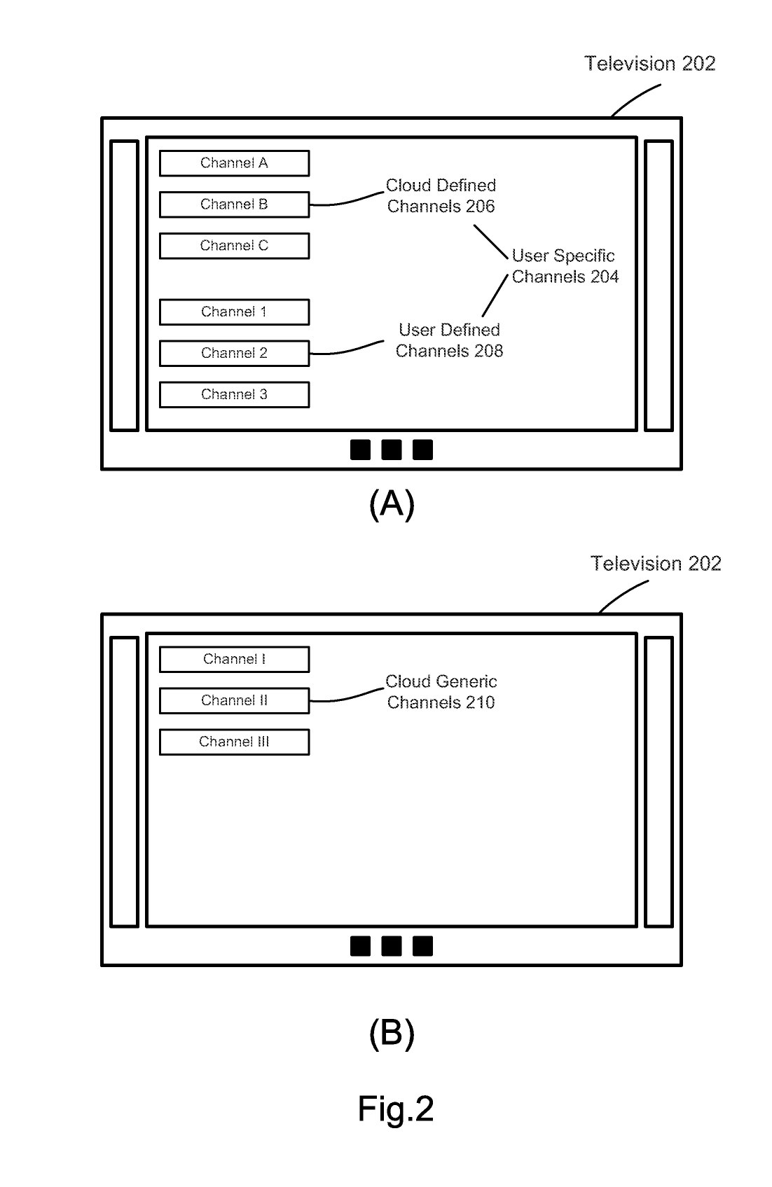

An exemplary UI 118 is illustrated in FIG. 2A. Television 202 is used exemplarily as electronic terminal 102. User specific channels 204 are displayed on display of television 202. User specific channels include cloud defined channel 206 and user defined channels 208.

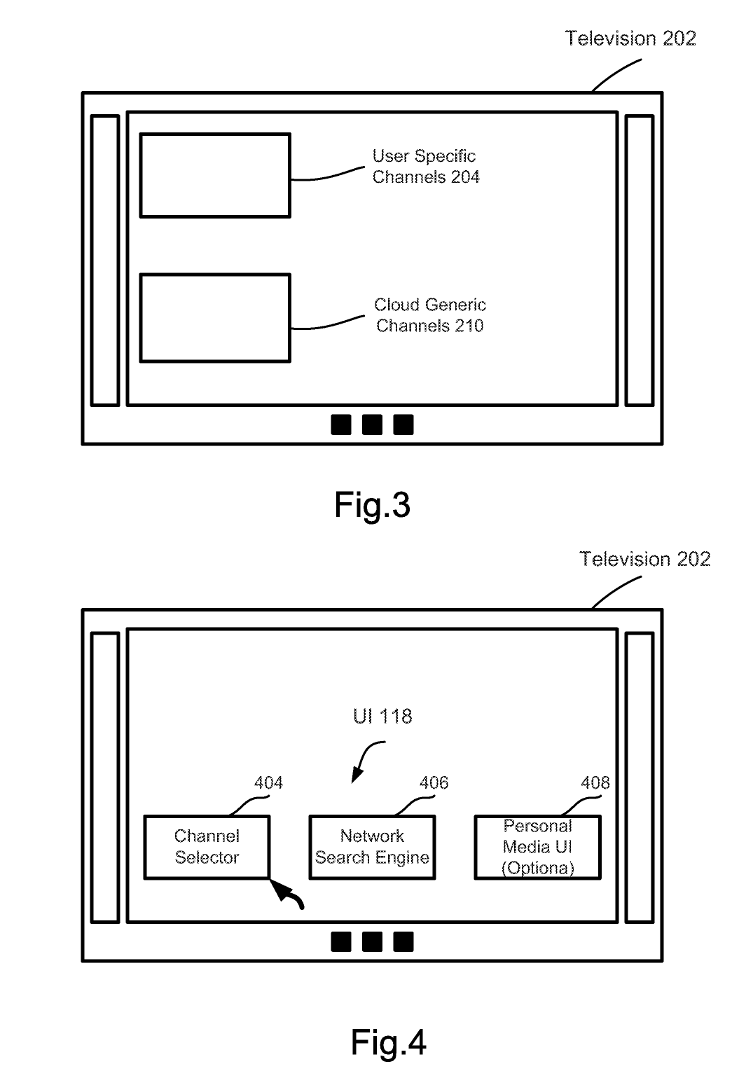

As shown in FIG. 2B, cloud generic channels 210 can also be displayed. Cloud generic channels 210 are the channels that can be accessed by many users of cloud 104. Cloud generic channels may be delivered by a service operator in cloud 104. The user can select a group of channels that are interested to him or her. Programs delivered by cloud generic channel 210 are based upon a predetermined schedule by the service operator. UI 118 can display any combination of cloud defined channels 206, user defined channels 208 and cloud generic channels 210. As shown in FIG. 3, user specific channels 204 and cloud generic channels 210 can be displayed on a single display of television 202.

FIG. 4 is a schematic diagram illustrating an exemplary user interface at its first hierarchical level. UI 118 at its first display includes a channel selector icon 404, a network search engine icon 406. The user can select channel selector 404 through user input device 114. In response to user selection, a list of user selectable channels is displayed on a second display of UI 118. The channels can be user specific channels and/or cloud generic channels as shown in FIGS. 2A-B and FIG. 3. The user can also select network search engine 406 through user input device 114. Upon the user's selection, a search box and a search button are displayed on a second display of UI 118. The user can key in a search query about a video program into the search box and actuates the search button. A plurality of potential results is displayed for the user's selection.

UI 118 at the first level can also include optionally personal media UI 408 pertaining to accessing personal media files stored in data storage 110 of electronic terminal 102 (television 202 is taken as example only). In response to user selection of personal media UI 408, a hierarchical user interface is rendered to the user for guiding the user to select a desired video program stored in the data storage.

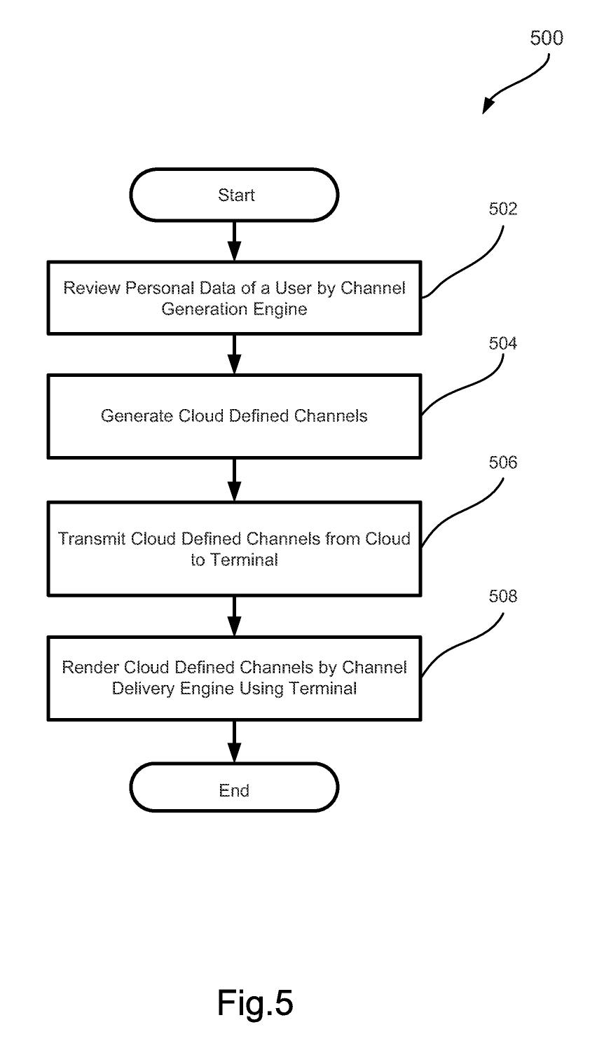

FIG. 5 is a flowchart illustrating exemplarily operation of generating cloud defined channels. Process 500 starts with process 502 that personal data 124 of the user is reviewed by channel generation engine 122. Cloud defined channels are then generated by channel generation engine 122 in step 504. Cloud defined channels are transmitted from cloud 104 to electronic terminal 102 through communication link 106 in step 506. Channel delivery engine 116 of terminal 102 displays received cloud defined channels on display 112 through UI 118 in step 508.

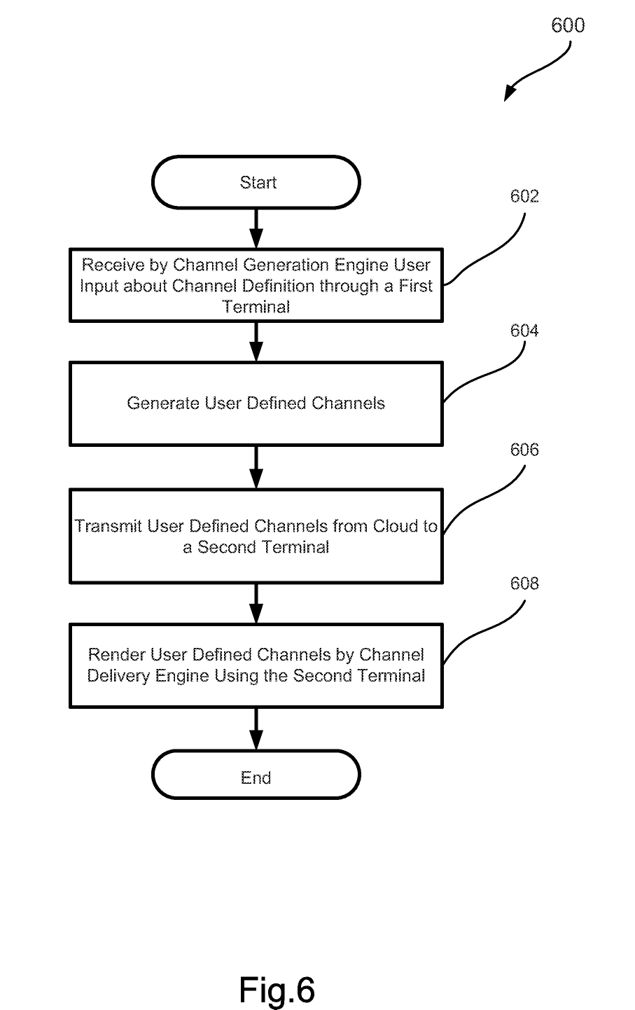

FIG. 6 is a flowchart illustrating exemplarily operation of generating user defined channels. Process 600 starts with step 602 that user inputs from a first electronic terminal about channel definitions are received by channel generation engine 122. User defined channels are generated by channel generation engine 122 in step 604 based at least upon received user inputs. In step 606, user defined channels are transmitted from cloud 104 to a second electronic terminal. Channel delivery engine 116 in the second electronic terminal displays received user defined channels on display of the second terminal in step 608. The first terminal and the second terminal may be different terminals. The first terminal and the second one may be the same one.

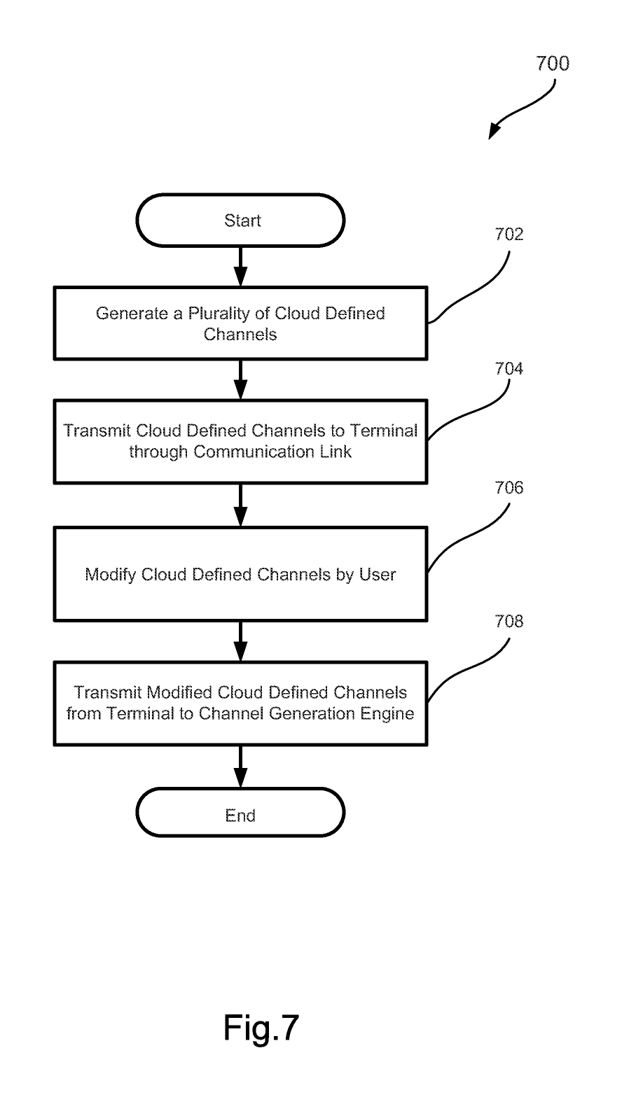

FIG. 7 is a flowchart illustrating exemplarily operation of modifying cloud defined channels by a user of the electronic terminal Process 700 starts with step 702 that cloud defined channels are generated by channel generation engine 122. The cloud defined channels are transmitted from cloud 104 to terminal 102 in step 704. Received cloud defined channels are modified by the user through user input device 114 in step 706. Modified cloud defined channels are transmitted from electronic terminal 102 to channel generation engine 122 in step 708.

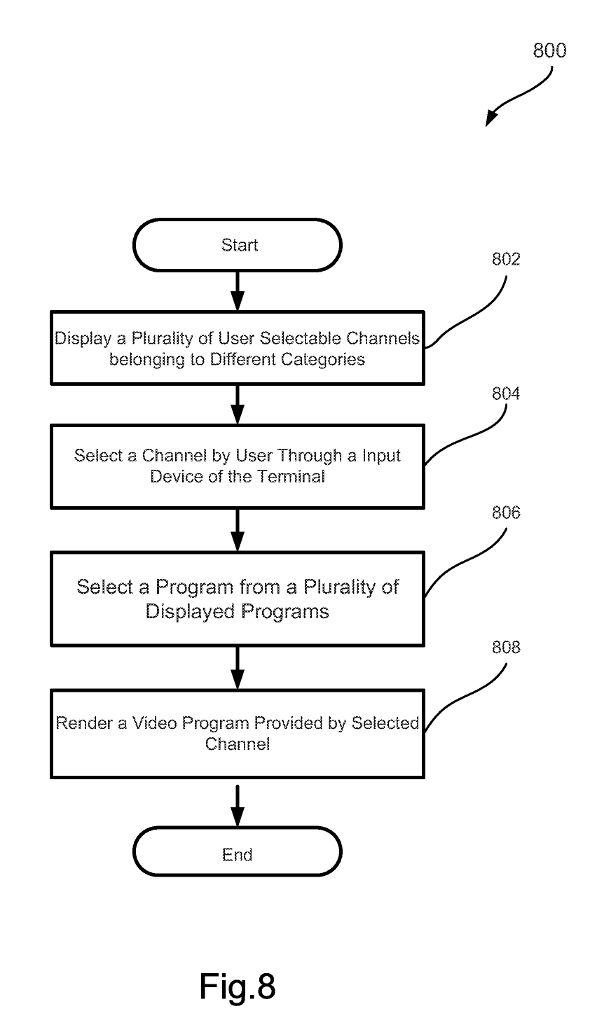

FIG. 8 is a flowchart illustrating that a video program is delivered from the cloud to the electronic terminal based upon the present system. Process 800 starts with step 802 that a plurality of user selectable channels including different categories is displayed on display 112 of electronic terminal 102. The categories include user specific channels 204 and cloud generic channels 210. User specific channels 204 further include cloud defined channels 206 and user defined channels 208. The user selects a channel in step 804 employing user input device 114 of electronic terminal 102. The user further selects a program of the channel in step 806. Selected video program is rendered in step 808 through electronic terminal 102.

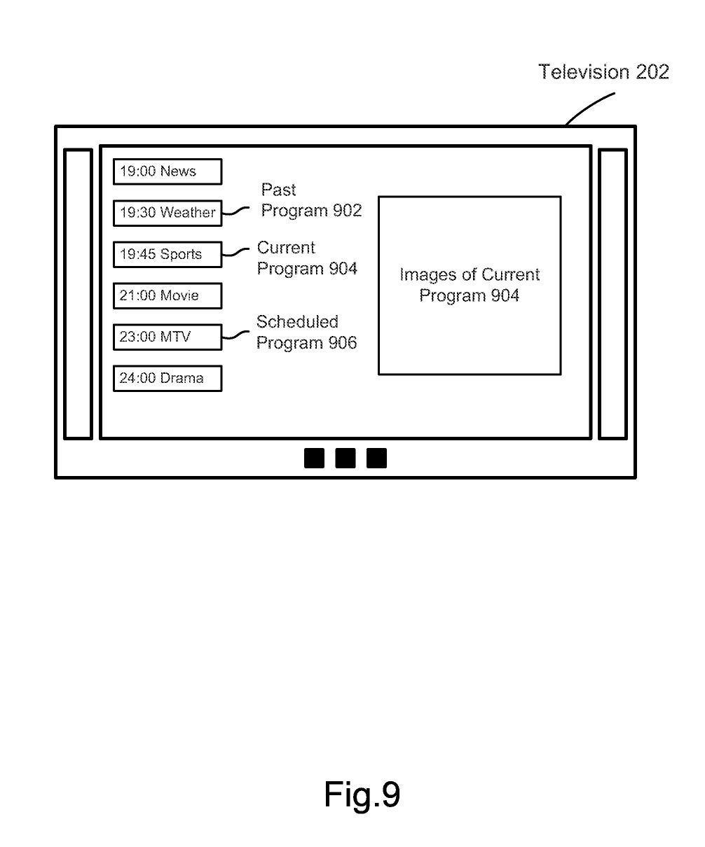

FIG. 9 is a schematic diagram illustrating an exemplary program list displayed on television 202. The program list includes past program 902, current program 904 and scheduled program 906. In an exemplary case, current program 904 is being broadcasted when the user enters the program list. In one aspect, the user may select a past program. Past programs may be stored in cloud 104. In response to user selection of the past program, selected program can be rendered to the user. An advertising message may be broadcasted before selected past program is rendered. One or more advertising messages may be rendered during rendering of the past program. In another aspect, the user may select a scheduled future program. Some of the scheduled programs may have already been accessible. Some of scheduled programs such as real time news may not be available ahead of the schedule. In response to user selection of the scheduled program, selected program can be rendered to the user. An advertising message may be broadcasted before selected scheduled program is rendered. One or more advertising messages may be rendered during rendering of selected program. The user may also need to pay for accessing the past or the scheduled future programs.

In yet another aspect, the program being rendered may be restarted from the starting point as requested by the user through user input device 114. An advertising message may be broadcasted before the program is restarted. One or more advertising messages may be rendered during rendering of the program. The user may also need to pay for restarting the program.

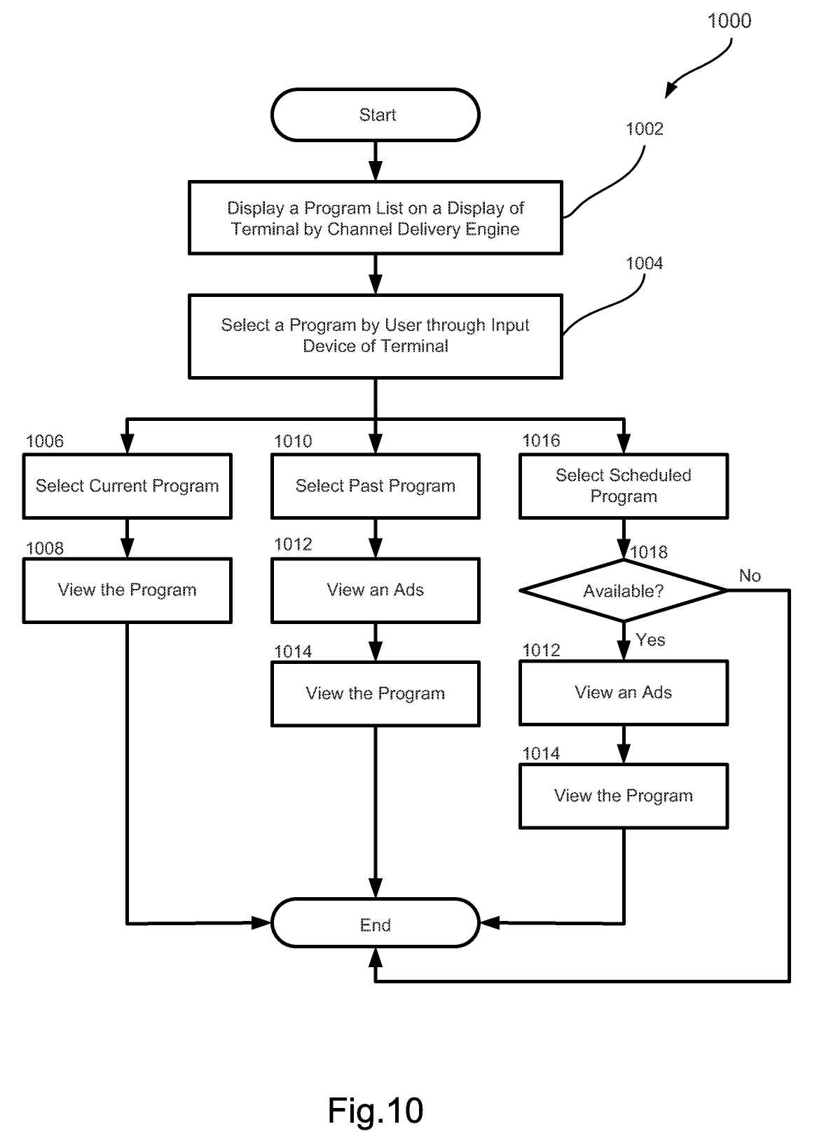

FIG. 10 is a flowchart illustrating exemplarily that advertising messages are delivered based upon the system. Process 1000 starts with step 1002 that a program list of selected channel is displayed on display 112 of electronic terminal 102. One of the programs in the program list is selected by the user in step 1004. If current program 904 is selected in step 1006, selected program is rendered in step 1008. If past program 902 is selected in step 1010, an advertising message is viewed in step 1012 before selected past program is rendered in step 1014. If scheduled program 906 is selected in step 1016, processor 108 decides in step 1018 if selected program is available. If result is positive, an advertising message is viewed in step 1012 followed by viewing selected program in step 1014. In another implementation, one or more advertising messages can be delivered during rendering the past and the scheduled program. In still another implementation, one or more advertising messages may also be viewed in accompanying with rendering of the current program.

1. A video program delivery system comprising:
a. an electronic terminal connected to the Internet; and
b. a channel generation engine located in the Internet pertaining to generating user specific channels for delivering video programs stored in the Internet,
wherein said user specific channels are displayed on said terminal through a user interface.

2. The system as recited in claim 1, wherein said user specific channels are determined by said channel generation engine based upon personal data of a user of said terminal.

3. The system as recited in claim 2, wherein said personal data further comprising a record of metadata of video programs viewed by the user.

4. The system as recited in claim 2, wherein said personal data further comprising demographical information of the user.

5. The system as recited in claim 2, wherein said personal data is stored in the Internet.

6. The system as recited in claim 2, wherein said personal data is stored in said terminal.

7. The system as recited in claim 1, wherein said user specific channels are determined based additionally on user inputs through an input device of said terminal.

8. The system as recited in claim 1, wherein said user specific channels can be modified by a user through an input device of said terminal.

9. The system as recited in claim 1, wherein said user interface further comprising user selectable means for selecting a video program through said user specific channels or through a network search engine.

10. The system as recited in claim 1, wherein said channel generation engine is a piece of software stored in a server or in a virtual server in the Internet.

11. A video program delivery system comprising:
a. a plurality of electronic terminals including a television and a mobile communication device;
b. a channel generation engine operated by a server or a virtual server located in the Internet pertaining to generating user specific channels for delivering video programs stored in the Internet; and
c. a user interface operated by said server or said virtual server pertaining to rendering a video program through said user specific channels by anyone of said plurality of electronic terminals.

12. The system as recited in claim 11, wherein said user specific channels are determined by said channel generation engine based upon personal data of a user of said terminal.

13. The system as recited in claim 11, wherein said user specific channels are determined based additionally on user inputs through anyone of said plurality of electronic terminals.

14. The system as recited in claim 11, wherein said user specific channels can be modified by a user through anyone of said plurality of electronic terminals.

15. The system as recited in claim 11, wherein said mobile communication device further comprising a mobile phone.

16. The system as recited in claim 11, wherein said mobile communication device further comprising a tablet or a laptop computer.

17. A method of delivering a video program comprising:
a. displaying user specific channels on a display of an electronic terminal connected to the Internet, said user specific channels are generated by a channel generation engine located in the Internet based upon personal data of a user of said terminal;
b. selecting one of said user specific channels by the user through an input device of said terminal;
c. displaying by a processor of said terminal a list of video programs of one of selected channels, said video programs including a past program, a current program and a scheduled future program;
d. selecting one of said video programs by a user through a user input device of said terminal;
e. rendering selected video program with at least one advertising message if the past or the scheduled future program is selected.

18. The method as recited in claim 17, wherein no advertising message is rendered if the current program is selected by the user.

19. The method as recited in claim 17, wherein said method further comprising rendering the current program from a starting point after rendering an advertising message.

20. The system as recited in claim 17, wherein said user specific channels are determined by a channel generation engine located in the Internet based upon personal data of the user.
